(19) United States
(12) Patent Application Publication
(10) Pub. No.: US 2007/0052123 A1
(43) Pub. Date: Mar. 8, 2007

(54) Vertical moulding of long concrete articles

(75) Inventor: Graeme Reginald Hume, Victoria (AU)

Correspondence Address: CONNOLLY BOVE LODGE & HUTZ LLP, P.O. BOX 2207, WILMINGTON, DE, 19899-2207, US

(73) Assignee: Vertech Hume Pty. Ltd., Werribee (AU)

(21) Appl. No.: 10/571,767

(22) PCT Filed: Oct. 6, 2004
(86) PCT No.: PCT/AU04/01353

§ 371 Date: Mar. 14, 2006

(30) Foreign Application Priority Data
Oct. 7, 2003 (AU) 2003905422

(51) Int. Cl. B28B 3/00

(52) U.S. Cl. 264/35; 264/333; 264/334; 249/175; 425/441

(57) ABSTRACT

Vertical moulds are provided for making concrete pipes poles or piles. The mould can be opened along its length and has an internal flexible rubber or polymer liner (5) in which the edges of the mould shell (63), that seal together when the mould is closed, incorporate a sealing strip (51) bonded to the mould liner (5) and supported on flanges (53) running parallel to the edges of the mould shell the attachment of the sealing strip (51) to the flanges (53) being arranged to allow the sealing strip (51) to follow the movement of the mould liner (5) during opening of the mould and removal of the moulded article. When moulding long hollow concrete articles of constant cross section an expandable core is used which can be contracted to allow easy removal of the articles of constant cross section from the mould. Also disclosed is a method of moulding long concrete articles in which an homogenous concrete mixture is subjected to a moulding pressure above (5) bar in the absence of vibration. The method is adaptable to making hollow poles or piles of annular non circular cross section especially elliptical poles or piles or poles with a rectangular base an elliptical body section and a circular top section.

This invention relates to improvements in long concrete products such as poles, piles and pipes and to the method of moulding such products.

### BACKGROUND OF THE INVENTION

The conventional method of making long concrete poles of adequate strength to weight is the spun cast method. This method is only used to make poles, piles or pipes of symmetrical cross section about the long axis. Another consequence of this process is that under the forces applied during spinning the aggregate in the concrete is unevenly distributed radially across the cross section of the pole, pile or pipe.

Non circular poles pipes or piles are unusual and not commonly made.

US design patent 438991 is for a concrete anchor with an elliptical base.

U.S. Pat. No. 5,081,806 discloses an elliptical foundation beam.

Japanese patent abstract 01015219 discloses a method of converting round metal pipe to elliptical.

Japanese 07119141 discloses an elliptical pipe for retaining walls.

Japanese 62161422 discloses a method of forming an elliptical steel pipe for concrete reinforcing.

The moulding of concrete pipes, annular poles or piles in a vertical mould has been proposed in U.S. Pat. Nos. 4,996,013 and 6,284,172. The mould is filled from the bottom and the concrete is compressed between an inner and outer mould by moving the inner mould outwardly using a flexible membrane. The product formed was a hollow pole tapering in cross section from base to top. The moulds were inverted so that the widest portion was at the top. In this method the pressure applied by the liners was no greater than 3 atmospheres and the concrete mix was vibrated during filling of the mould. There is usually one or two vertical mould seals depending on whether the mould is hinged or in two parts and the seal was provided by bending the rubber liner around the mould edge. This seal has proved in adequate as the liner tends to crack and the thickness is inadequate for the tolerances over the 12 metre length of the mould.

U.S. Pat. No. 3,809,513 discloses a moulding process, which is horizontal and in which pressure is applied via a membrane that allows dewatering. Vibration is used to complete compaction.

It is an object of this invention to provide an improved method of making hollow concrete products which is also capable of making products that are of constant cross section or are non circular. It is also an object of this invention to provide non circular products which are more cost effective. It is also an object of this invention to provide a mould adapted to operate in the improved method and make long hollow concrete articles of constant or changing cross section or of non circular cross section.

### BRIEF DESCRIPTION OF THE INVENTION

To this end the present invention provides a method of moulding long concrete articles in which an homogenous concrete mixture is subjected to a moulding pressure above 5 bar in the absence of vibration.

This invention is partly predicated on the realization that compaction/water extraction, prior to mould release, can be achieved without vibration if the pressure applied by the internal liners is adequate. This is primarily due to the concrete being maintained as an homogenous mixture during the filling of the mould. This is preferably achieved in accordance with the method disclosed in PCT/AU03/00481 which discloses a mould liner with water drainage tubes that are closed off during filling of the mould. To reach a stage where the mould can be opened and the pole can be moved to a curing station is a function of holding time and pressure applied. By increasing the pressure above 5 bar the holding time can be reduced significantly and the finish quality is improved.

A consequence of maintaining an homogenous concrete mix and maintaining adequate pressure is that the aggregate distribution in the formed pole is more even across the wall cross section than in alternative processes, such as the spun cast method.

The mould filling and water reduction steps are similar in sequence to those described in U.S. Pat. No. 6,284,172 the contents of which is incorporated herein by reference.

Another consequence of this improvement is that the outer mould shell [former] needs to be stronger to withstand pressures of up to 9 bar.

It is also a consequence of the increased pressure that the mould seal be adequate.

In another aspect of the invention there is provided a mould for a long concrete article in which the mould can be opened along its length and has an internal flexible rubber or polymer liner in which the edges of the mould shell, that seal together when the mould is closed, incorporate a sealing strip bonded to the mould liner and supported on flanges running parallel to the edges of the mould shell the attachment of the sealing strip to the flanges being arranged to allow the sealing strip to follow the movement of the mould liner during opening of the mould and removal of the moulded article.

This arrangement allows the mould to remain sealed under pressures of up to 9 bar and to allow tolerances of ±5 mm in the mould closure gap along its length. In another aspect this invention is concerned with manufacturing long, hollow concrete articles that are of constant cross section. To achieve this, the present invention provides a vertical mould for forming long hollow concrete articles in which the inner face of the mould is formed by a cylindrical flexible liner and within the flexible liner is disposed an expandable core that can contract radially when the moulded concrete article is being removed from the mould. The expandable core needs to be strong enough to withstand the internal mould pressure during pumping operation. This can be achieved by having a core consisting of a first central shaft and a second concentric shaft slidable on the first shaft and an outer beam connected at each end of the first shaft such that movement of the second shaft relative to the first shaft moves the outer beam radially, relative to said first shaft.

In another aspect this invention provides a novel long vertical concrete pole or pile that has a non circular cross section that can be constant or changing from the base toward the top. Preferably the cross section is elliptical.

This aspect of the invention is predicated on the realization that the amount of concrete and reinforcing steel used in a pole can be optimized by using a non circular cross section.

Hollow elliptical poles will require less reinforcing because the wider base allows the structure to need less reinforcing. This represents a significant cost saving per pole and may also result in concrete saving. The use of an elliptical pole means that ground placement can only be in one orientation and this overcomes a problem that is encountered in the erection of poles.

In service power poles are subject to three major loads imposed on them with a fourth occurring when an outer conductor breaks. Two of the three major loads are bending loads and the largest is at right angles to the line of the conductors and is more than twice the load applied along the line of the conductors. Thus the pole has two separate bending requirements one at right angles to the other. Using the moulding method of this invention a preferred inner and outer shape can be made including thicker walls and or more reinforcing where the bending load is greatest and relatively thinner or less reinforcement in the walls subjected to the lesser bending load.

While making a pole with elliptical shape confers optimum properties above ground the soil loads in the ground are increased particularly along the long axis, because the bearing area has been reduced. To overcome this difficulty it is preferred by providing the butt of the pole with a square sided cross section to better distribute the loads into the surrounding soil. The pole can also incorporate a tapered butt so that the concrete section reduces toward the bottom of the pole. Using the moulding method of this invention a pole of variable cross section along its length is possible including a circular cross section at the top so that current hard ware and fittings can be used.

For some products such as hollow piles or pipes, a constant cross section is desired which means that the core of the mould needs to be of constant cross section. This can create problems when the core has to be extracted from a long moulded product. With a tapered product a short vertical movement creates a space between the core and the pole or pile but this is not the case with a constant internal diameter.

In another aspect this invention provides a mould core for a long hollow concrete article such as a pole or pile which carries a flexible liner which can be pressurized to apply pressure to the moulded concrete and an expandable frame of rigid materials which can be moved outwardly

### DETAILED DESCRIPTION OF THE INVENTION

Some preferred embodiments of the invention will be described with reference to the drawings in which:

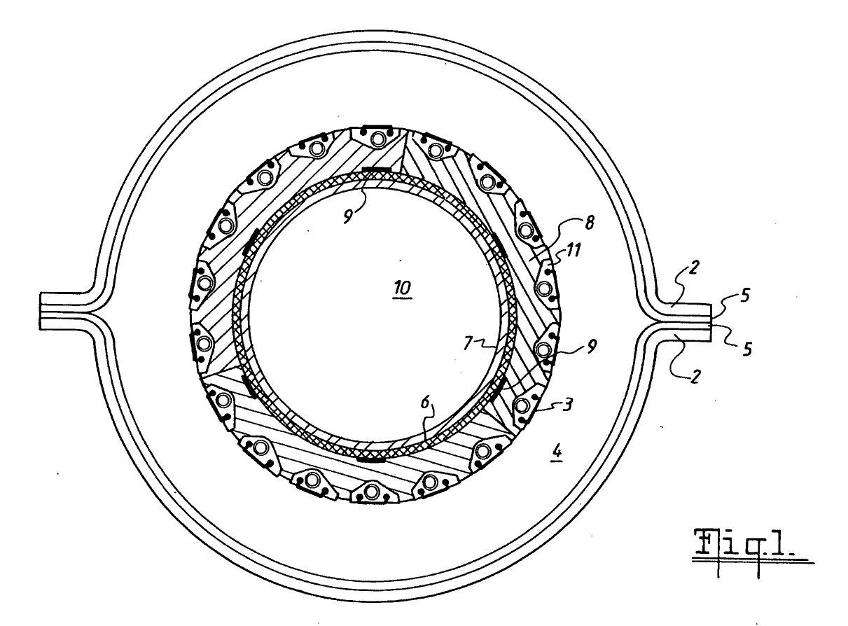

FIG. 1 is a plan view of the top cross section of the mould;

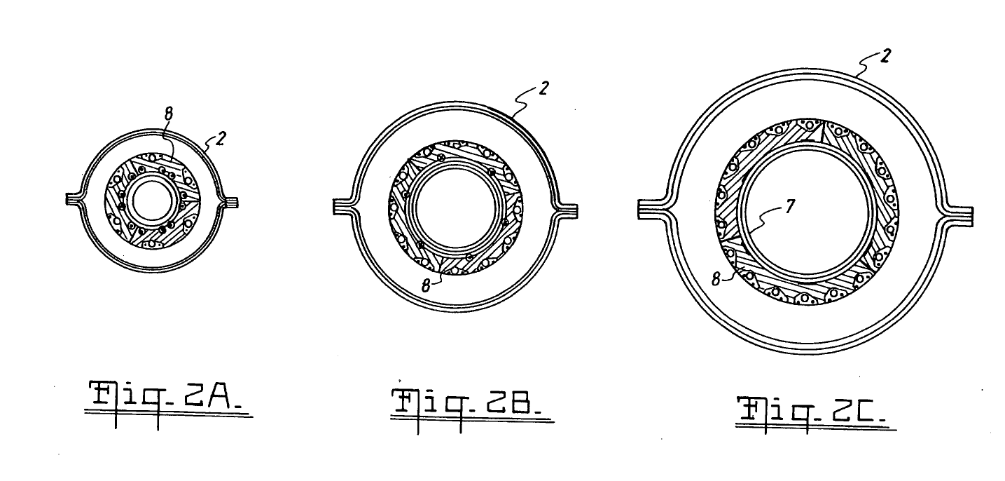

FIG. 2 is a series of plan views of 3 sections of a tapered mould of this invention;

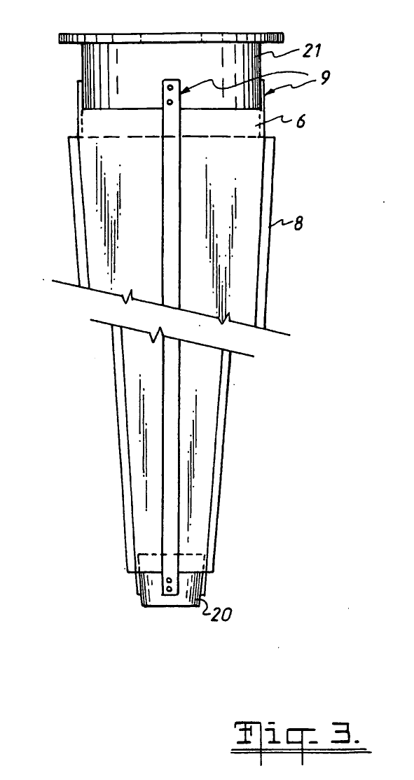

FIG. 3 is a vertical section of the core shown in FIGS. 1 and 2;

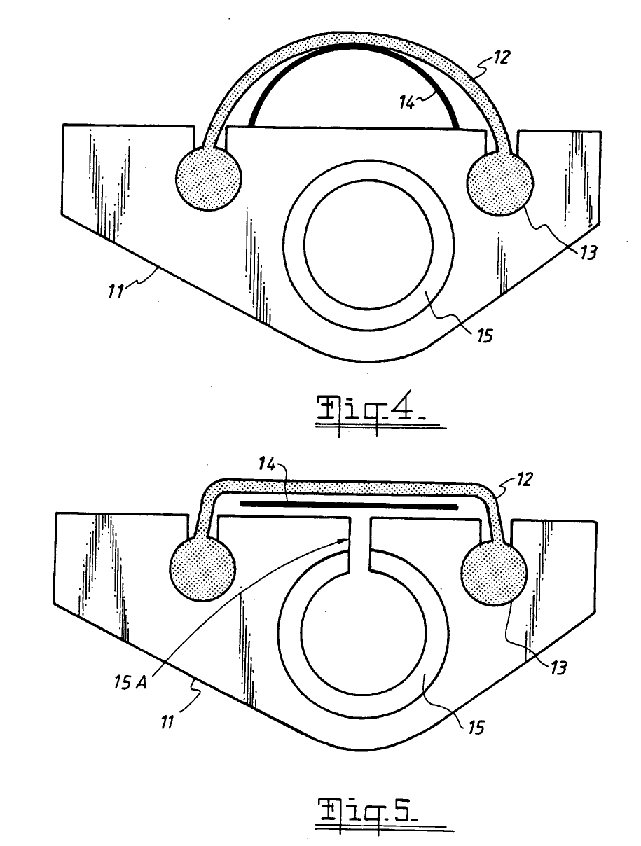

FIG. 4 is a detail of a drainage channel during stripping and cleaning;

FIG. 5 is a detail of a drainage channel during dewatering;

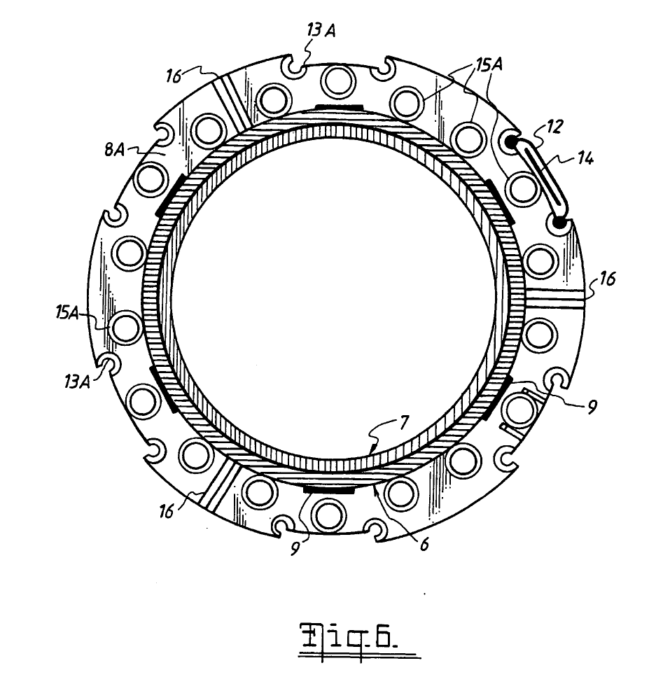

FIG. 6 is a plan view of a section of the core mould according to a second embodiment of the invention;

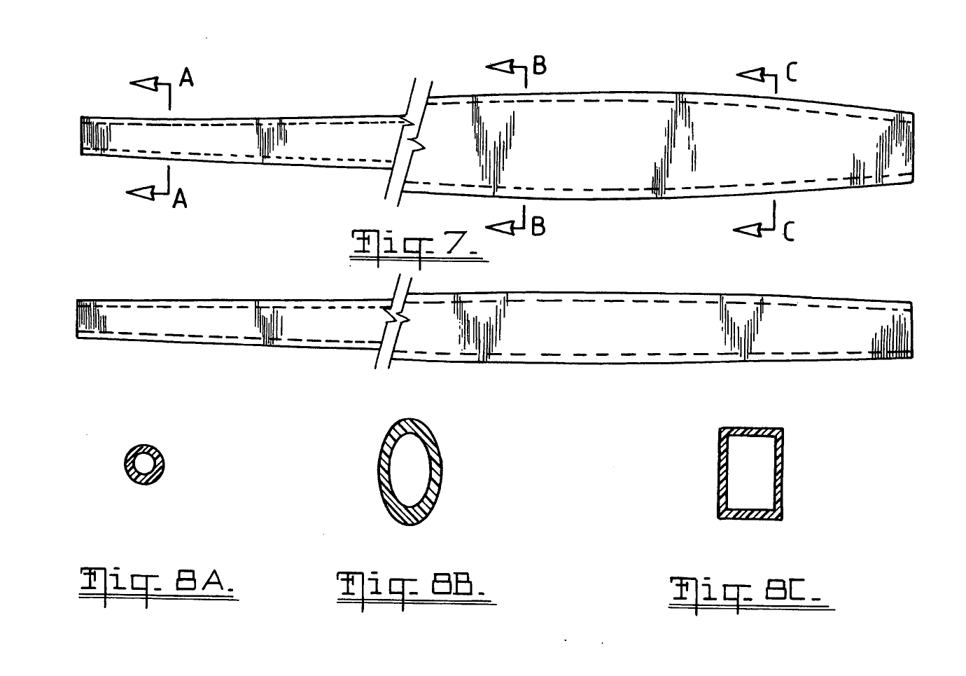

FIG. 7 shows a side elevation of a non symmetrical pole of this invention;

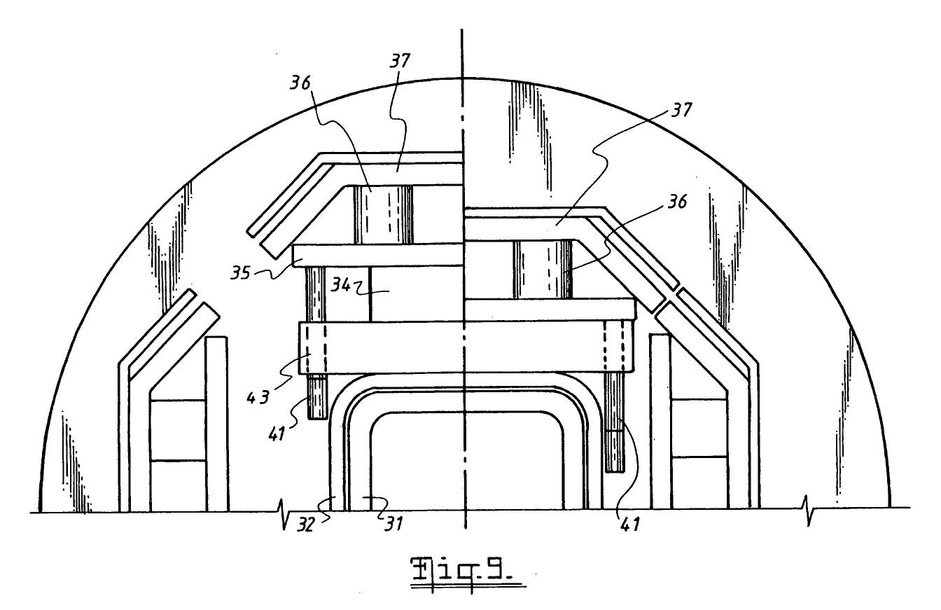

FIG. 8 shows a series of cross sections of the pole of FIG. 7;

FIG. 9 is plan view of the expandable core used in the present invention when products of constant cross section such as pipes or piles are being made;

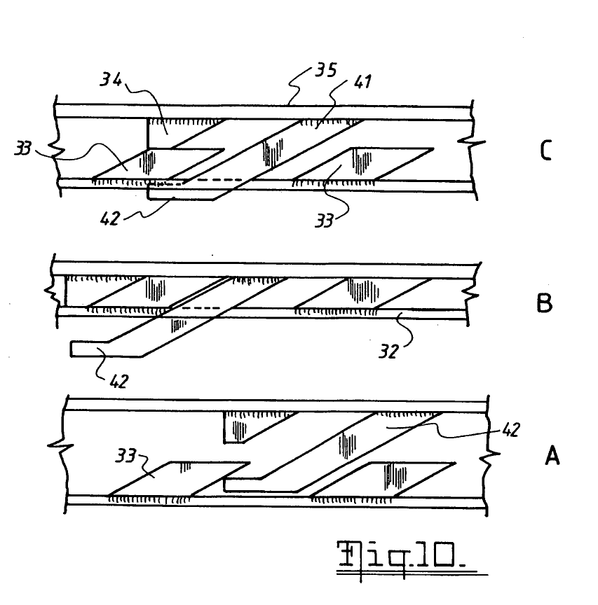

FIG. 10 is a schematic representation of three positions of the expandable core shown in FIG. 9;

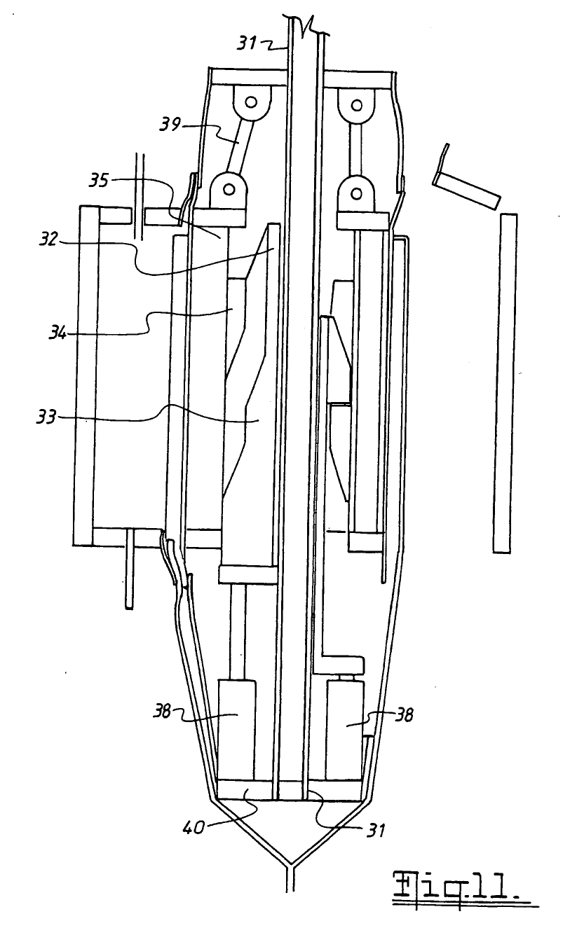

FIG. 11 is a is a schematic side elevation of the expandable core;

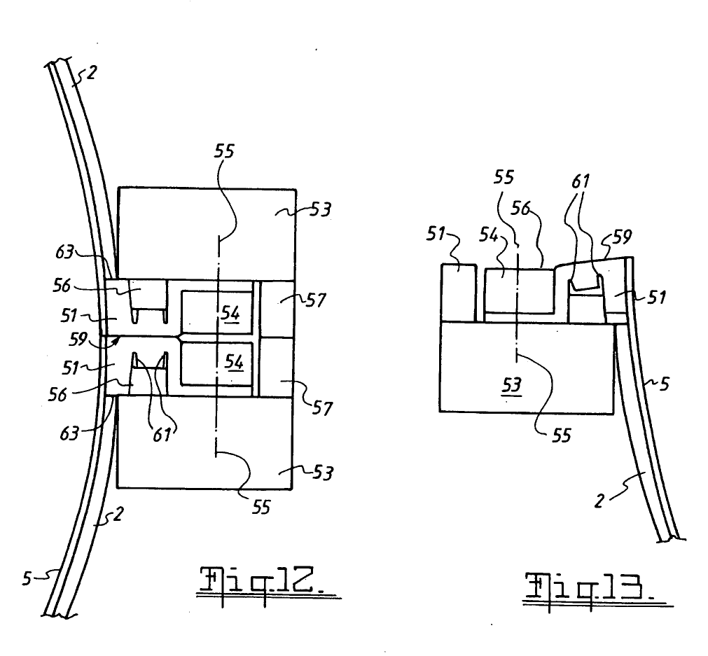

FIG. 12 shows a detail in plan view of the mechanism for achieving a seal between the two edges of the mould shell;

FIG. 13 illustrates one edge seal of the mould shell when the mould is open.

In FIGS. 1 and 2 the mould is shown in plan view with the mould shells 2 and the liner 5 defining the outer mould. The annular mould space 4 lies between the filter media 3 of the inner mould and the mould liner 5. The mould space 4 is tapered to form an annular tapered pole which is formed upside down in the mould with the largest cross section at the top of the mould. FIG. 2A shows the cross section one third above the bottom of the mould and 2B shows the cross section two thirds from the bottom. FIGS. 1 and 2C show the cross section at the top of the mould. The drainage channels 11 are extruded synthetic plastic strips arranged around the outer face of the inner liner 8 made from castable polyurethane. An elastic rubber bladder 6 lies on the inner face of the liner 8. A tapered inner steel pig 7 is moved axially to expand the elastic rubber bladder 6 to press the inner liner outwardly to its normal diameter that defines the mould space 4. When the concrete is being dewatered the inner space 10 is pressurized with air and the pig 7 is moved axially upwards to create a space between the bladder 6 and the pig 7. This outward radial movement is about 10% of the radial width of the mould space 4. When the air pressure is reduced after dewatering, the bladder 6 contracts and moves away from the inner surface of the moulded product in space 4.

It has been found that in some cases during filling of the mould that the resistance to the flow of concrete at core surface is such that the bladder can be torn from its mounting. Further when the pig has been raised and the bladder deflated some sections of the bladder may remain in contact with the concrete and be difficult to remove. When the core is raised the bladder is stretched and this can cause damage to the drainage system and the bladder. To overcome these problems the elastic bladder 6 is stabilized by stiffening members 9 of polyaramid strips attached to the bladder 6 and to the steel ends 20,21 of the inner mould as shown in FIG. 3. These strips should be stiff but flexible to allow for changes of shape at the interface of the concrete and the filter media. This stabilization assists in the separation of the inner mould from the concrete during removal of the moulded product from the mould.

The number of drainage channels 10 is determined by the circumference of the inner mould. Preferably they are as close together as possible to maximise the drainage capacity. As can be seen in the FIGS. 2A to 2C the number at the top of the mould is eighteen, which decreases to twelve at two thirds of the height and six at one third of the height. Thus six of the drainage extrusions extend the full length of the inner mould liner but the other twelve only extend part of the length. The drainage tubes 15 in these shorter extrusions continue to the bottom of the inner mould and drain into the main outlet pipe at the bottom of the inner liner. In other respects the drainage channels and tubes may be as described in the applicants copending patent application PCT/AU03/00481.

As shown in FIGS. 4 and 5 each drainage channel 11 includes include the drainage tubes 15 and also a filter media 12 anchored at points 13 to the extruded drainage channels 11. In FIG. 5 a drainage hole 15A is shown. These are spaced 50 mm apart in the vertical drainage tube 15. The filter media 12 is biased outwardly by an open weave coarse filter media 14 to create a space that is easily flushed clear during cleaning to ensure that the filter media does not become clogged or obstructed by concrete fines. During the dewatering process the media 12 and 14 are flattened against the extrusion 11. Alternatively the extrusion can be reduced in size by forming two parts separately namely the tube 15 and the filter medias 12 and 14 which are then cast into the polyurethane liner 8.

FIG. 6 illustrates a second embodiment of the core and drainage system. Again the core is fitted to a steel pig 7 which fits within the rubber bladder 6 reinforced by the strips 9. The drainage system comprises 3 longitudinal sections of cast polyurethane 8A which are bonded together at the joints 16 to form a tapered cone that fits the circumference of the bladder 6. Each section 8A is cast in a mould which positions the retaining slots 13A machined from 6 mm nylon tubes to anchor the filter media 12 (as in FIGS. 4 and 5) and also the drainage tubes 15A formed from 8 mm nylon tubes. The number of tubes is the same as in the embodiment of FIG. 1 namely 18 at the top of the mold which corresponds to the widest part of the pole and then decreasing towards the bottom of the mold.

FIGS. 7 and 8 illustrate a pole made according to this invention. The bottom of the pole is rectangular as shown in FIG. 8C. The middle portion of the pole is elleptical as shown in FIG. 8B The top section as shown in FIG. 8A is circular in cross section.

An expandable core for use in forming cylindrical piles and pipes of constant diameter is shown in FIGS. 9 to 11. The core incorporates a central four sided vertical beam 31 and a second similar beam 32 slidable over the beam 31 by the aid of hydraulic cylinders 38 each mounted on plate 10 which is attached to beam 31. The beam 31 is suspended from the main support mast and guided vertically within the core.

The expandable frame consists of four sets of elements one on each of the four sides of beam 32. Each set of elements includes a ramp 33 fixed to beam 32, matching ramp 34 fixed to the strip 35. Between the ramps 33 and 34 are legs 41 (see FIGS. 9 and 10) which straddle the beam 32. The strip 35, the blocks 36 and the section 37 form a continuous beam equal in length to the length of the pipe or pile to be molded and supported by the ramps 33 and 34. The beam structure formed by elements 35, 36, and 37 are attached to the central beam 31 by the link 39. There are four such links.

In operation the movement of the beam 32 relative to beam 31 results in the outward movement of the elements 35, 36 and 37. The legs 41 ensure that ramps 33 and 34 prevent the beam formed by elements 35, 36 and 37 becoming disconnected from the beam 32 during the operation of the mould and core. This is ensured by maintaining the protrusion 42 beneath the ramp 33.

FIG. 10A shows the elements in position when the mold core is assembled.

FIG. 10B shows the position of the elements when the mold is being stripped and the inner core is removed from within the hollow pipe or pile. FIG. 10C shows the elements in position during the pumping of concrete into the mold and during dewatering of the concrete in the mold.

The entire core is fabricated from steel sections able to withstand the pressures in the mould and support the inner liner of the mould.

With reference to FIGS. 12 and 13 the mould seal arrangement is shown for sealing between the edges of two mould halves 2 and their associated liners 5. The seal at line 59 is achieved by providing two sealing strips 51 which have a circumferential length on the mould liner of about 16 cm each, which is adequate to accommodate tolerances of up to 5 mm in the mould edge along the 12 metre length of the mould.

The sealing strips 51 are supported by flanges 53 welded to the outside of the mould shells 2 and extend parallel to the mould shell edges 63. The flanges 53 each carry a support block 56 welded or bolted to the flange 53. The sealing strips 51 fit over the blocks 56 and are adhered to the edges of the mould liner 5 adjacent the mould opening back to the mould shell edge 63. The sealing strips 51 are fastened to the flanges 53 by clamping strips 54 which in this embodiment are fastened to the flange 53 by bolts 55. The portion of the sealing strip 51 which fits over the block 56 incorporates two slots 61 to allow resilient movement of the sealing strip. As shown in FIG. 11 the face 59 of the sealing strip 51 is extended circumferentially when the mould is open and compressed circumferentially when the mould is closed. The stops 57 limit the compression when the moulds are closed.

This arrangement prevents bending of the mould liners 5 and provides a sealing strip much thicker than the mould liner 5, which moves in concert with the mould liner during opening and closing of the mould. This eliminates damage to the concrete article by movement of the seal into the article.

The sequence of forming a pole is as follows
a) the reinforcing cage is transferred into the open mould
b) the mould is closed
c) the mould core is lowered into the mould so that the reinforcing cage is centred on the core
d) the mould locking bars are raised and locked into position relative to the core
e) the mould end caps are closed
f) concrete is pumped into the mould space and is maintained as an homogenous mix during filling
g) when the mould is filled air pressure within the core of mould is maintained above 5 bar preferably 7 bar and water is allowed to drain from the mould liners.
h) When dewatering is completed the inner air pressure is reduced
i) the top end cap is removed
j) the concrete at the bottom is split
k) the outer seal is unlocked and lowered
l) the core is raised
m) the mould is opened.
n) the dewatered pole is removed by carrying the pole by the reinforcing cage.

When filling the mould space with concrete it is important to sense when the space has been filled with concrete so that the concrete pump can be stopped to avoid placing undue pressure on the mould shells and the inner mould. This may be achieved by an inspection port hole in the top of the mould, a pressure sensor to detect the increase that occurs when the mould is filled or preferably an inductive proximity sensor is fitted in the top of the mould.

The method as outlined above results in a dewatered product that can be removed and transported to a curing station without any deterioration in integrity even though the molding and dewatering operation only takes 30 minutes.

Those skilled in the art will realize that the present invention enables poles, pipes or piles of varying cross sections to be made in a more economical method than the prior art in a plant with a smaller foot print than in conventional operating plants because of the vertical molding process of this invention

Those skilled in the art will realise that the embodiments described above are examples only and the invention can be carried out in many potential embodiments.

1. A method of moulding long concrete articles in which an homogenous concrete mixture is subjected to a moulding pressure above 5 bar in the absence of vibration.

2. A method as claimed in claim 1 in which loss of water from the concrete during filling of the mold is inhibited to maintain an homogenous concrete mix within the mold.

3. A method as claimed in claim 1 in which the pressure is applied for a time sufficient to produce a self supporting molded article.

4. A method as claimed in claim 3 in which reinforcing is placed into the mold prior to filling the mold and the molded article is removed from the mold by support means fastened to the reinforcing.

5. A method as claimed in claim 4 in which the mold is tapered in cross section increasing from the base of the mold and the reinforcing is an open conical cage of complementary cross section.

6. A mould for a long concrete article in which the outer mould can be opened along its length and has an internal flexible rubber or polymer liner in which the edges of the mould shell, that seal together when the mould is closed, incorporate a sealing strip bonded to the mould liner and supported on flanges running parallel to the edges of the mould shell the attachment of the sealing strip to the flanges being arranged to allow the sealing strip to follow the movement of the mould liner during opening of the mould and removal of the moulded article.

7. A mould as claimed in claim 6 in which each abutting edge of the mould shell incorporates an outwardly extending flange adjacent said edge with a sealing block on the abutting face of the flange and said sealing strip is shaped to fit over said sealing block and said flange.

8. A mould as claimed in claim 7 in which the face of the sealing strip in contact with the sealing block incorporates recesses to allow the sealing strip to flex during movement of the mold shell.

9. A long vertical concrete pole or pile that has an annular non circular cross section that can be constant or increasing from the base toward the top.

10. A pole or pile as claimed in claim 9 wherein the cross section at least in part is elliptical.

11. A vertical mould for forming long hollow concrete articles of constant diameter in which the inner face of the mould is formed by a cylindrical flexible liner and within the flexible liner is disposed an expandable core that contracts radially when the moulded concrete article is being removed from the mould.

12. A vertical mould as claimed in claim 11 in which the core consists of a central four sided beam with a set of movable elements on each side linked by a linkage to the central beam such that movement of the linkage changes the position of the elements radially relative to the central beam.
